(19) United States
(12) Patent Application Publication
(10) Pub. No.: US 2020/0193420 A1
(43) Pub. Date: Jun. 18, 2020

(54) DATA MANAGEMENT SYSTEMS AND METHODS

(71) Applicant: Bit Key, Inc., San Francisco, CA (US)

(72) Inventors: Henry Michael Vogel, Saratoga, CA (US); Aleksandar Dukic, Sunnyvale, CA (US); Guangda Zhang, Belmont, CA (US); Rui Wang, Los Altos, CA (US)

(21) Appl. No.: 16/560,638

(22) Filed: Sep. 4, 2019

Related U.S. Application Data
(60) Provisional application No. 62/726,953, filed on Sep. 4, 2018.

(51) Int. Cl. G06Q 20/36; G06Q 20/38; G06Q 20/40

(52) U.S. Cl. CPC G06Q 20/3678; G06Q 20/3829; G06Q 2220/00; G06Q 20/389; G06Q 20/4012; G06Q 20/40145

(57) ABSTRACT

Example data management systems and methods are described. In one implementation, a data management system includes a carbon key configured to store at least one authentication factor associated with a user. The system also includes a hardware wallet configured to communicate with the carbon key. The hardware wallet includes a fingerprint sensor configured to scan a fingerprint of the user, a display configured to receive a personal identification number (PIN) from the user; and a system on chip (SOC) configured to authenticate the carbon key, the fingerprint, and the PIN. Additionally, the SOC can sign a transaction based on authentication of at least two of the carbon key, the fingerprint, and the PIN.

### RELATED APPLICATIONS

This application claims the priority benefit of U.S. Provisional Application Ser. No. 62/726,953, entitled “Data Management Systems and Methods,” filed on Sep. 4, 2018, the disclosure of which is hereby incorporated by reference herein in its entirety.

### TECHNICAL FIELD

The present disclosure relates to digital identity and asset management systems and methods that provide secure storage and retrieval of various types of data.

### BACKGROUND

Blockchain decentralized computing platforms are growing quickly. This blockchain technology supports many potential applications and use cases, such as crypto currencies and other types of data. Example crypto currencies include Bitcoin, Bitcoin Cash, Ethereum, and the like. Crypto currencies are virtual assets having real value that leverage blockchain technology to enable users to securely own and transfer the virtual assets anonymously. These crypto currencies leverage a decentralized ledger and can be transferred without the need for a third party intermediary, such as a bank or a government entity.

In example blockchain technologies, each user has a digital identity (e.g., a private key) that is typically a hexadecimal-based string of numbers and characters, such as a 64 character string. These private keys allow users to securely “sign” transactions such as sending a virtual asset (e.g., Bitcoin or Ethereum) from one user to another. And while these transactions all have a public address and are recorded publicly on an immutable blockchain, the users' private keys and digital identities are kept secret and secure.

Although blockchain technologies offer many benefits, there are also many problems for users who are trying to securely and conveniently manage their private keys and virtual assets. For example, a significant number of security breaches have resulted in stolen crypto currency, stolen digital identities, and the like. Thus, maintaining the security of users' private keys/digital identities is critical to securing their crypto currency and other data or virtual assets that are important to users of various blockchain technologies.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a hardware wallet, a carbon key, and a computing system.

FIG. 3 illustrates an embodiment of a hardware wallet and a carbon key.

FIG. 4 illustrates an embodiment of a method for initializing a new hardware wallet.

FIG. 5 illustrates an embodiment of the data stored in a hardware wallet and a carbon key.

FIGS. 6A and 6B illustrate an embodiment of a method for initializing a new hardware wallet and registering for a digital identity and asset management service.

FIG. 7 illustrates an embodiment of the data stored in a hardware wallet and a carbon key.

FIG. 8 illustrates an embodiment of a method for signing transactions.

FIG. 9 illustrates an example situation in which a user has lost or forgotten the PIN associated with their hardware wallet.

FIG. 10 illustrates an example situation in which a user lost their hardware wallet or the hardware wallet was stolen.

FIG. 11 illustrates an example situation in which a user has lost or forgotten the PIN associated with their hardware wallet.

FIG. 12 illustrates an example situation in which a user lost their hardware wallet or the hardware wallet was stolen.

FIG. 13 illustrates an example workflow for generating a master key and an encrypted seed phrase.

FIG. 14 is a block diagram illustrating an example computing device.

### DETAILED DESCRIPTION

It will be readily understood that the components of the present systems and methods, as generally described and illustrated in the figures herein, could be arranged and designed in a wide variety of different configurations. The following detailed description of the embodiments of the data management systems and methods is not intended to limit the scope of the invention, as claimed, but is merely representative of certain examples of presently contemplated embodiments in accordance with the invention.

As mentioned above, with the growing use of blockchain technologies, it becomes important for users to maintain the security of their digital identities and private keys in order to maintain the security of their crypto currency and other critical data or virtual assets associated with blockchain technologies. Over the past few years, significant security breaches of internet-based software wallets (which hold users' private keys online), theft of crypto currency being held by online exchanges which act as beneficiaries and hold crypto currency on behalf of users, and other hacks and theft have been reported with growing frequency, size, and scale. Some of the losses from these breaches have reached tens and hundreds of millions of dollars.

As a result of these breaches, various hardware wallets have been developed which securely hold a user's private keys on a dedicate device with a secure micro-controller and operating system to enable more security and secure transactions. Although hardware wallets are typically more secure than most software wallets as they are mostly “air gapped,” they generally require users to keep a randomly generated pseudonym or seed phrase which typically needs to be written down on a piece of paper or other physical medium and then securely stored separate from the hardware device.

Example seed phrases are 12 to 24 words, typically 4 to 8 characters each, and which need to be entered in a specific order. A seed phrase can then be used by the user (or any person who gets access to it) to recreate the private key being stored by a hardware wallet and then “sign” transactions and transfer ownership of the crypto currency and virtual assets owned by that private key. The intent of these seed phrases is to let users restore their hardware wallets if the original device becomes inoperable or is lost or stolen. However, securely managing and keeping these seed phrases safe is difficult, unreliable and often very risky. Additionally, the need for paper pseudonyms negates any security provided by the technology in the hardware device itself. The systems and methods described herein also include optional “user” entropy, to harden the security level of the derivation process, that is used as a salt to the derivation function which provides a 12 or 24 words seed which in turn will be translated to the master private key. Also, these systems and methods store encrypted seed phrases on both secure element storage and carbon key storage to offer an option to reveal the seed phrases if the user needs it later but still maintain the paperless paradigm. The existing hardware wallets, software wallets, and online exchanges also fail to offer a good solution for beneficiary services and transfer of virtual assets to other users after an owner's death without the owner needing to share private information—their account information and password, seed phrase, and/or private keys. Although particular examples discussed herein refer to beneficiaries, similar systems and methods may be used with custodians, guardians, and other types of beneficiary relationships.

The systems and methods described herein provide secure storage of crypto currency, digital identities, virtual assets, and other critical data. In some embodiments, the described systems and methods use a Multi-Factor/Multi-Signature Authentication (MF/MSA) system along with a hardware wallet and other components, as described herein. These systems and methods also provide a unique business model that solves the issues discussed above and provides a secure and convenient way to manage digital identity, virtual assets, and the like for users and their named beneficiaries.

In some implementations, the MF/MSA system provides a secure, convenient, and flexible solution by enabling a hardware wallet to offer four-factor authentication (4FA) or more factors. For example, in addition to two standard factors including the hardware wallet device itself (something the user has) and the user's password (something the user knows), the MF/MSA system also uses a user's biometric fingerprint (something unique to an individual user) and a second device called the Carbon Key which has a unique number to encrypt and decrypt their private keys. As described herein, the described approach uses a customer's biometric data (e.g., fingerprint) to reliably store or encrypt and decrypt biometric private keys. Thus, the described systems and methods do not need a paper seed phrase to restore a broken, stolen, or lost device. Additionally, MF/MSA enables the system to offer a solution which allows users to transfer digital assets to one or more named beneficiaries in a highly secure, private, and still de-centralized manner that does not require them to share any of their private information—account information, passwords, private keys or seed phrases—with any third party before they die. As discussed herein and illustrated in the figures, specific implementations may include four main components: a hardware wallet, a carbon key, a desktop application running on a computing system, and a digital identity and asset management service.

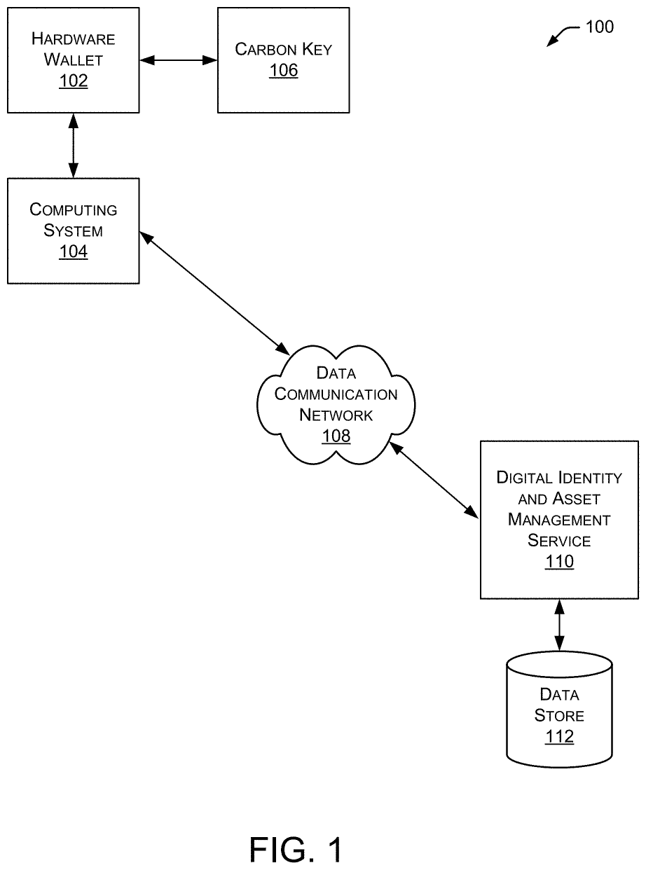

FIG. 1 is a block diagram illustrating an environment 100 within which an example embodiment may be implemented. A hardware wallet 102 is coupled to a computing system 104 and a carbon key 106 such that hardware wallet 102 can communicate with computing system 104 and carbon key 106. Hardware wallet 102 is a dedicated device that securely stores a user's encrypted private keys. Computing system 104 may include a laptop computer, desktop computer, tablet computer, portable computing device, smartphone, and the like.

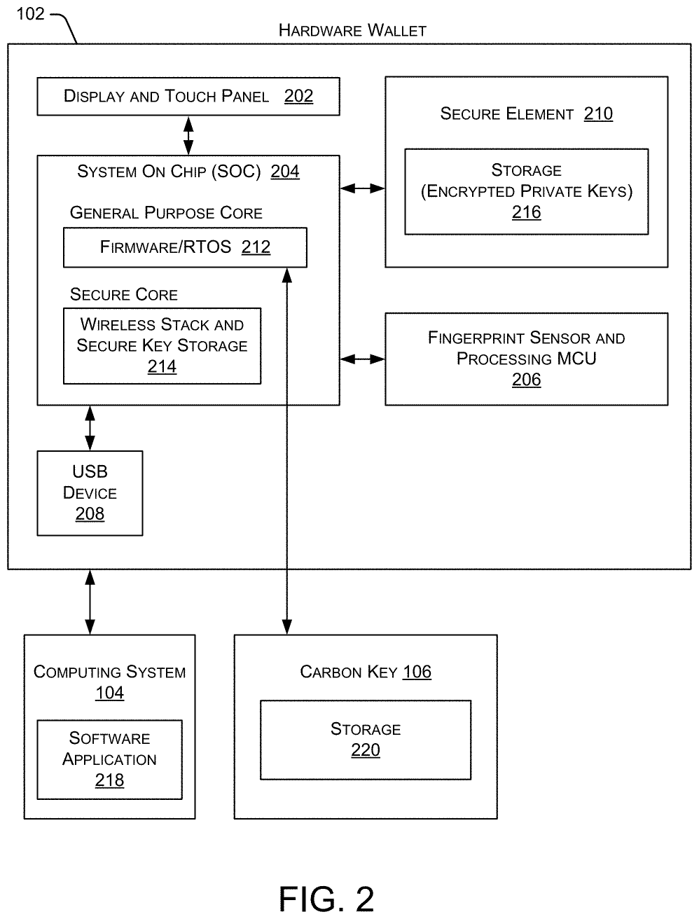

In some embodiments, hardware wallet 102 communicates with computing system 104 via a wired connection and/or a Bluetooth Low Energy (“BLE”), Near Field Communication (“NFC”) or other wireless connection. In some embodiments, hardware wallet 102 communicates with carbon key 106 via a physical connection between electrical contacts on each component and/or a Bluetooth low energy, NFC or other wireless connection. The communication links between hardware wallet 102 and carbon key 106 as well as computing system 104 are secure communication links. Additional details regarding hardware wallet 102 and carbon key 106 are described below with respect to FIG. 2. Hardware wallet 102 may also be referred to as a “digital wallet,” “a crypto wallet,” “a crypto hardware wallet,” or a “cryptocurrency hardware wallet.”

The “carbon” in the term “carbon key,” for the carbon key 106 device refers to a “carbon” copy. In some embodiments, carbon key 106, includes two important pieces of data which are part of the described systems and methods. First, carbon key 106 includes encrypted copies of the user's PIN and fingerprint keys. These are stored only on hardware wallet 102 and carbon key 106. Second, carbon key 106 includes a fourth key which is generated by the System on Chip secure core on hardware wallet 102 and then stored on carbon key 106. This becomes the fourth factor which can be used along with the user's password and fingerprint keys to restore their master key on replacement hardware wallet 102 if their original hardware wallet 102 is lost, stolen or becomes inoperable (3 out of 4 factors in our MF/MSA system).

As shown in FIG. 1, computing system 104 is coupled to a digital identity and asset management service 110 via a data communication network 108. In some embodiments, data communication network 108 includes any type of network, such as a local area network, a wide area network, the Internet, a cellular communication network, a Bluetooth low energy or NFC wireless connection or any combination of two or more data communication networks. As discussed herein, digital identity and asset management service 110 provides various hardware wallet 102 initialization functions, beneficiary functions, carbon key distribution functions, and other activities discussed herein. A data store 112 is coupled to digital identity and asset management service 110 for storing data, application programs, and the like.

FIG. 2 is a block diagram illustrating an embodiment of a hardware wallet, a carbon key, and a computing system. As shown in FIG. 2, hardware wallet 102 includes a display and touch panel 202 (e.g., a touchscreen display), a system on chip (SOC) 204 with a general purpose core and a secure core, a secure element 210, a fingerprint sensor and processing MCU 206, and a USB (Universal Serial Bus) device 208 (also referred to as a “USB port”). In some implementations, display and touch panel 202 is a touchscreen display that allows a user to enter data, interact with a graphical user interface, set up their digital identity and enter passwords, create private keys, register with a digital identity and asset management service, manage their virtual assets, sign transactions, and the like. System on chip 204 performs various operations with respect to operation of hardware wallet 102, as discussed herein. As shown in FIG. 2, system on chip 204 includes a firmware/RTOS (Real Time Operating System) 212 (also referred to as a general purpose core) and a wireless stack and secure key storage 214 (also referred to as a secure core). This dual core approach separates the general operations (e.g., rendering user interface information on a display) from the secure operations (e.g., generating private keys, splitting private keys, and signing transactions) so the general operations to not interfere with the secure operations. Firmware/RTOS 212 provides an operating system for hardware wallet 102 and supports various functions performed by the hardware wallet. In some embodiments, the firmware and kernel on system on chip 204 are custom software. In particular implementations, the described systems and methods may use multiple libraries, such as blockchain libraries and crypto libraries from ST Microelectronics and other open source libraries, as well as software that is on the MCUs from the chip manufacturers.

Hardware wallet 102 also includes fingerprint sensor and processing MCU 206, which can read fingerprint data from a user. Hardware wallet 102 may use any type of fingerprint sensor that is capable of reading fingerprint data from a user. This fingerprint data is used to identify the user and encrypt and decrypt a sub-key which can restore a user's private master key. In some embodiments, hardware wallet 102 may include any type of biometric sensor, such as fingerprint sensor 206, a retina sensor, a face sensor, a voiceprint sensor, EKG sensor, and the like. The systems and methods described herein can implement a variety of multi-factor authentication techniques. Some embodiments include additional factors by, for example, splitting up the secret sharing algorithm to include more factors. These additional factors may include other data and signals, such as BLE (Bluetooth Low Energy) or GPS (Global Positioning System) prints of locations or people near each other, video images, and the like.

USB device 208 allows hardware wallet 102 to communicate with computing system 104 via a secure USB connection. For example, hardware wallet 102 may communicate with a software application 218 executing on computing system 104. By establishing and connecting with software application 218, the user is able to interact with the software application using display and touch panel 202 to manage the user's public keys, send signed transactions to the blockchain to transfer virtual assets, check virtual asset balances, check virtual asset prices, manage the user's digital identity, and the like.

Hardware wallet 102 further includes secure element 210 that contains storage 216. In some embodiments, secure element 210 is a secure MCU with the main purpose of storing the private key. The secure MCU may be a microcontroller that has built-in security and performs the operations necessary to generate the private keys. Storage 216 stores various data and other information used by hardware wallet 102, such as encrypted sub-keys which as part of Shamir's Secret Sharing Algorithm can decrypt and restore a user's private master key.

As shown in FIG. 2, carbon key 106 includes storage 220, which is a general purpose memory element that may be used as an independent authentication factor and a backup of the user's information for beneficiary transfers. In some embodiments, storage 220 includes encrypted information from the user and their named beneficiaries. In certain implementations, carbon key 106 may store other information (e.g., using storage 220) such as a user PIN, a beneficiary PIN, a user fingerprint key, a beneficiary fingerprint key, a carbon key fourth secret key, and the like. In other implementations, carbon key 106 may also store other encrypted sub-keys for other factors and signatures.

In some embodiments, carbon key 106 is used to recover a user's hardware wallet 102 and restore their secure private keys if any of the following occur: hardware wallet 102 is lost/stolen/becomes inoperable, a user forgets their password, or a user is unable to enter their fingerprint.

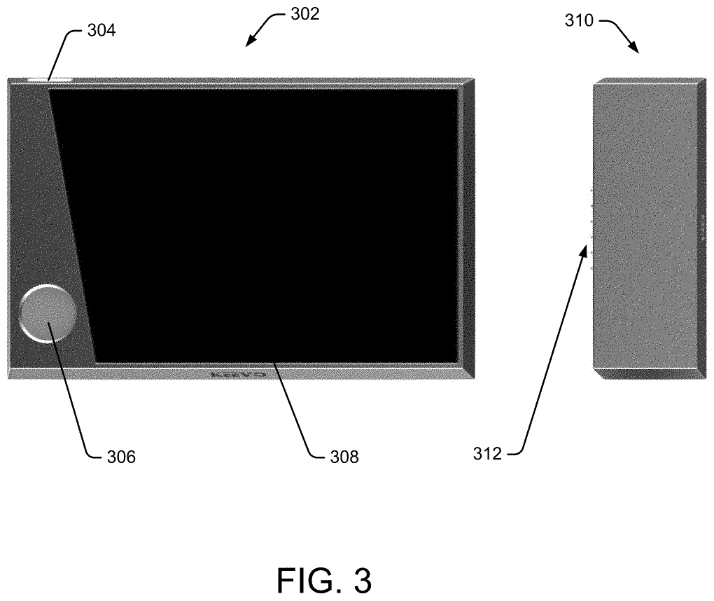

FIG. 3 illustrates an embodiment of a hardware wallet and a carbon key. A hardware wallet 302 may be similar to hardware wallet 102 discussed herein. Hardware wallet 302 includes a power button 304, a fingerprint sensor 306, and a display 308. Power button 304 turns hardware wallet 302 on and off. Fingerprint sensor 306 reads a user's fingerprint when the user's finger is placed on fingerprint sensor 306. Display 308 may be a touchscreen display that allows a user to interact with hardware wallet 302.

In some embodiments, a carbon key 310 has one or more electrical contacts that electrically communicate with corresponding electrical contacts on hardware wallet 302 (not shown). These electrical contacts allow carbon key 310 to communicate data and other information with hardware wallet 302.

Hardware wallet 302 and carbon key 310 can be manufactured from a variety of materials, such as CNC machined aluminum alloy with a bead-blasted finish, a molded glass-fiber reinforced ABS with a rubberized texture applique, and the like.

In some embodiments, software application 218 (FIG. 2) is a downloadable software application that enables users to easily and conveniently manage their public keys and virtual assets including functionality such as checking balances and ownership associated with their digital identity, confirming transactions (both sent and received virtual assets), seeing the value of crypto currencies like Bitcoin based on third party exchange information, transferring virtual assets, such as crypto currency, to other user's public addresses, and the like. Software application 218 is a highly secure solution, but still may be connected to the internet. As such, the communication protocol between hardware wallet 102 and software application 218 prevents tampering with hardware wallet 102.

In some embodiments, digital identity and asset management service 110 provides additional benefits to users of hardware wallet 102. This is an optional service and is not required for hardware wallet 102 to function properly. For example, users who register for digital identity and asset management service 110 will receive additional security, convenience, and other potential benefits to manage their digital identity and assets. In some implementations, digital identity and asset management service 110 provides users the ability to securely transfer to a third party and rely upon the third party to securely store their carbon key 106. In some embodiments, the third party is the entity that manufactures and/or sells hardware wallet 102. Digital identity and asset management service 110 protects the user's information in an encrypted manner and allows users to easily retrieve and restore their digital identity and private key in the case of misfortune, such as losing hardware wallet 102 or if hardware wallet 102 becomes inoperable.

In some embodiments, digital identity and asset management service 110 also allows users to designate and initialize named beneficiaries. Beneficiaries are additional user identities who will encrypt hardware wallet 102 and carbon key 106 with individual factors such as a PIN (Personal Identification Number) and fingerprint. In this case and upon certain verifiable circumstances (such as death of the user), digital identity and asset management service 110 can provide beneficiaries with a user's carbon key 106 and the ability to retrieve the users private key and restore/reset the private key and designate new beneficiaries.

In particular implementations, digital identity and asset management service 110 will also include other potential solutions and benefits for registered users. For example, these solutions and benefits may include:
Enhanced and extended hardware wallet warranties
Discounts for replacement and upgrade device purchases
Insurance coverage for identity theft and/or loss of digital assets
Access to buy and send gift packages (e.g., bundled hardware wallet and carbon keys with pre-loaded crypto currency and digital identity and asset management service registrations)
Access to and ability to participate in user-to-user loans and interest-bearing HODL savings accounts
Discounted or free exchange services for crypto currency trading
Additional digital asset solution beyond crypto currencies (e.g., photo storage, tickets, government issued IDs, digital records management, etc.)
Other services

The systems and methods described herein use a multi-factor authentication system (e.g., three-factor authentication). In some embodiments, the multi-factor authentication system is based on Shamir's secret sharing algorithm (which is essentially an application of the Lagrange polynomial). In some implementations, the described systems and methods add a second tier or multiple additional tiers of authentication factors.

An important concept in MF/MSA is to require a k out of n MF/MSA to authenticate and validate a transaction. Given a master key (noted as Key0, the master key can be considered as a seed phrase or private key of all cryptocurrencies), the system divides this Key0 into multiple factors: F1, F2, . . . , Fn. Each factor is unique and independent. A factor could any type or category or keys. For example, a factor Fn could be any of the following:

F1—a device like the hardware wallet

F2—a second type of device like the carbon key

F3—a type of biometric data like a fingerprint (series of vectors, images, etc.)

F4—another type of biometric data like an optical scan or facial image

F5—a defined user's (e.g., the hardware wallet owner) password or PIN (e.g., a 6 or more alpha-numeric character string) as inputted by the defined user

F6—another defined user's (e.g., the hardware wallet owner's named beneficiary) password or PIN (e.g., a 6 or more alpha-numeric character string) as inputted by the defined user

F7—a defined GPS lat-long ring-fenced set of coordinates which much be read and entered by a given device (e.g., the 10 meters within the defined center of the user's home or specific location as captured by the user's hardware wallet upon initialization)

Fn—any number of other types of defined factors

That said, having any one factor alone, e.g., F1 or the hardware wallet as in the example above, cannot reveal the data from any other factor. Any k of these factors will be able to reveal the master key Key0.

In a particular implementation, the systems and methods will use the following factors:

F1—hardware wallet, it serves as one factor itself

F2—user's PIN, beneficiary's PIN (encrypted and stored in carbon key)

F3—user's fingerprint, beneficiary's fingerprint (encrypted and stored in carbon key)

F4—carbon key, carbon key is served as an independent factor

In this implementation, any 3 out of 4 factors (from F1 to F4 will be required to decrypt the master Key0 and sign a transaction.

In other embodiments, this MF/MSA approach can introduce any number of new factors, such as another type of carbon key detachable/connected device, another type of biometric information, another type of user, and the like. Additionally, alternate embodiments may introduce new factorial rules, such as 6 out of n. In some situations, other developers using the described systems and methods may define their own k out of n MF/MSA factors and rules.

In some embodiments, the systems and methods may introduce factors that include a second layer of key sharing encryption. For example, F5K1, F5K2, F5K3 where 2 out of 3 key sharing is required for F5. In a particular implementation, other situations may benefit from this type of key factor organization, such as de-centralized hierarchical approval rights within a large enterprise or multi-level/multi-locational organization. For example, an enterprise could define the CEO as F5 where he or she alone can authenticate and executed a transaction, but where each SVP who reports to the CEO can also have an F5 key factor (e.g., F5Ki for SVP1, F5Kii for SVP2, and so on) and where at least two SVPs are required to sign and authenticate in order to decrypt and retrieve the F5 key.

Listed below are examples of when/how an owner of a hardware wallet and subscriber to the digital identity and asset management service could use the described systems and methods to sign and execute transactions:

If a user wants to send Bitcoin which they own with their private key stored on a hardware wallet, they would just need to use their hardware wallet, enter their PIN, and fingerprint. These 3 out of 4 factors (k out of n) would be enough to decrypt the Master Key0 so they can sign the transaction. Thus, the user would not need the 4th Factor, the carbon key, to decrypt the master key.

If a user loses their hardware wallet and wants to restore their master key on a new hardware wallet, the digital identity and asset management service would send the user a new “blank” hardware wallet along with the user's carbon key which the digital identity and asset management service has in its secure cold storage vault. The user would then connect their own personal carbon key to the new hardware wallet and enter their PIN and fingerprint. Again, these 3 out of 4 factors (k out of n) would be enough to decrypt the Master Key0 so they can sign the transaction. In this case, the transaction would be to create a new F1 for the new hardware wallet. In other words, with the carbon key and their other two factors, the user could restore a new hardware wallet.

If a user forgets their hardware wallet PIN, they can request the digital identity and asset management service to send them their carbon key which the digital identity and asset management service has in its secure cold storage vault. The user could then connect their own personal carbon key to their hardware wallet and scan their fingerprint. Again, these 3 out of 4 factors (k out of n) would be enough to decrypt the Master Key0 so they can sign the transaction. In this case, the transaction would be to create a new PIN or F2 for the hardware wallet and carbon key. Thus, with the user's hardware wallet, the carbon key, and the user's fingerprint (any 3 out of 4 factors), the user can restore and reset the 4th Factor, their PIN.

If someone steals a user's hardware wallet F1, the thief could still not sign any transaction as they would not have either the user's PIN, biometric information, or carbon key.

If the digital identity and asset management service tried to recreate the user's Master Key0 by somehow using the carbon key that is stored in cold vault storage, it would not be possible because the digital identity and asset management service wouldn't have 2 of the user's other Factors (the hardware wallet, the user's PIN, or the user's biometric keys).

If a user, who has registered with the digital identity and asset management service and setup a beneficiary, dies, the digital identity and asset management service will follow certain agreed upon procedures to document and validate the user's death (e.g., log in as the beneficiary using certain identification information and providing valid proof of a user's death like an apostilled original copy of the original user's death certificate) and then enable the beneficiary to access/use the hardware wallet and sign transactions. In a particular embodiment, the digital identity and asset management service can:
Validate the user's death
Authenticate the beneficiary and their contact information
Transfer and include the beneficiary's encrypted data onto the carbon key
Send the carbon key to the beneficiary
The beneficiary can then connect the carbon key to any hardware wallet to recover the Master Key0 and reset all the factors using their two factors (their PIN (F2K2)) and their biometric information (F3K2)).
Upon resetting the factors, the beneficiary will then become the new owner of the Master Key0. They will be able to reset the PIN (F2K1) and enter their biometric information (F3K1).

The beneficiary will also be prompted to register for the digital identity and asset management service upon which time they can also initialize and set up their own beneficiaries and utilize the digital identity and asset management service to securely store and retrieve their carbon key.

When receiving a hardware wallet and carbon key for the first time, users will be guided through a setup and registration process. At this time, users will initialize both the hardware wallet and carbon key, and setup their other factors and, optionally, their beneficiaries.

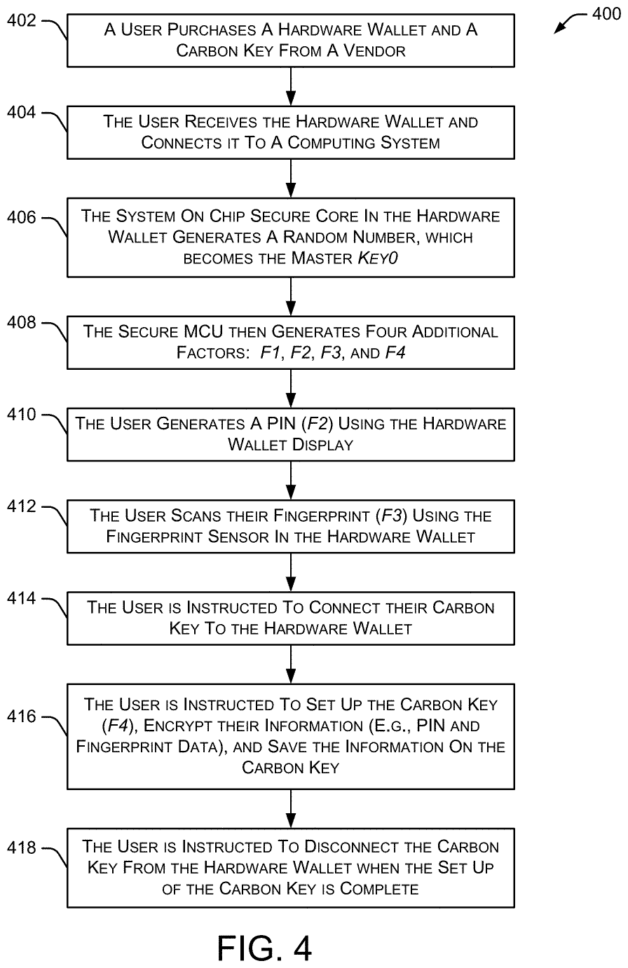

FIG. 4 illustrates an embodiment of a method 400 for initializing a new hardware wallet. In the example of FIG. 4, the user purchases a hardware wallet and a carbon key, but does not register with the digital identity and asset management service. In this situation, certain authentication factors are not created, and certain keys are not encrypted (e.g., the carbon key).

Initially, a user purchases 402 a hardware wallet and a carbon key from a vendor or other entity. The user receives 404 the hardware wallet and connects it to a computing system or another power source. The system on chip secure core in the hardware wallet generates 406 a random number, which becomes the Master Key0. After the Master Key0 is generated, the secure MCU generates 408 four additional authentication factors: F1, F2, F3, and F4. As discussed herein, these additional authentication factors are:

F1—hardware wallet factor

F2—user's PIN factor

F3—user's fingerprint factor

F4—carbon key factor

Method 400 continues as the user generates 410 a PIN (F2) using the hardware wallet display. The user's PIN is used to encrypt F2, so the result is encrypt(F2,PIN). The user then scans 412 their fingerprint (F3) using the fingerprint sensor in the hardware wallet. The user's fingerprint is used to encrypt F3, so the result is encrypt(F3,fingerprint). In some embodiments, the user is presented with an option to register with the digital identity and asset management service. In the example of FIG. 4, the user chooses not to register with the digital identity and asset management service.

Next, the user is instructed to connect 414 their carbon key to the hardware wallet. The user is then instructed to set up 416 the carbon key (F4), encrypt their information (e.g., PIN and fingerprint data), and save the information on the carbon key. This set up 416 of the carbon key can be accomplished via the hardware wallet display. Finally, the user is instructed to disconnect 418 the carbon key from the hardware wallet when the set up of the carbon key is complete. When the set up is complete, the user can disconnect the carbon key from the hardware wallet. At this point, the encrypted user information, along with the carbon key factor F4 is stored securely on the carbon key.

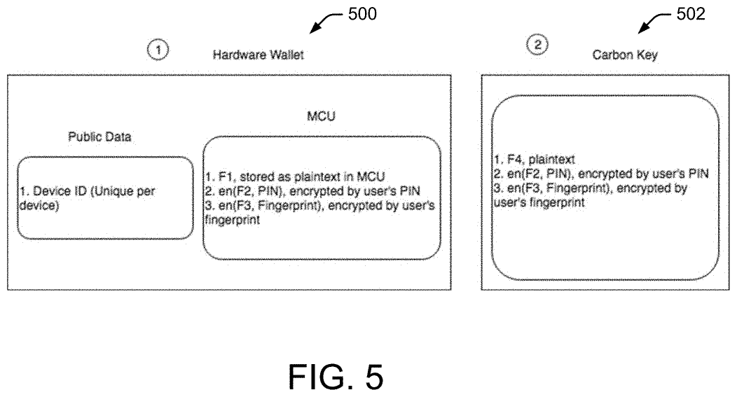

FIG. 5 illustrates an embodiment of the data stored in hardware wallet 500 and carbon key 502 after completing method 400 discussed above. As shown in FIG. 5, hardware wallet 500 contains a device ID, which is unique to hardware wallet 500, and various factors stored in the secure MCU. Additionally, carbon key 502 contains various factors, as discussed herein.

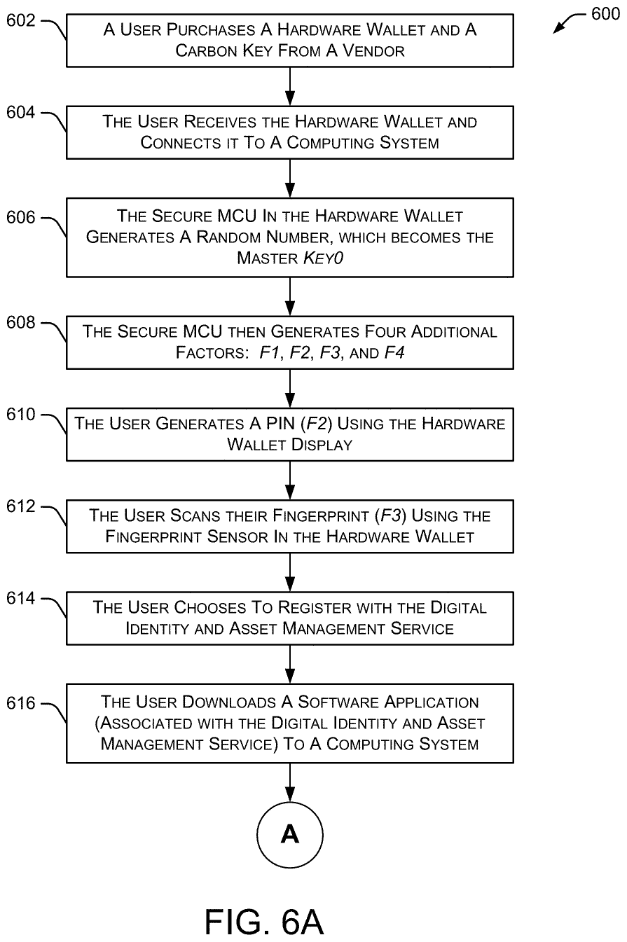

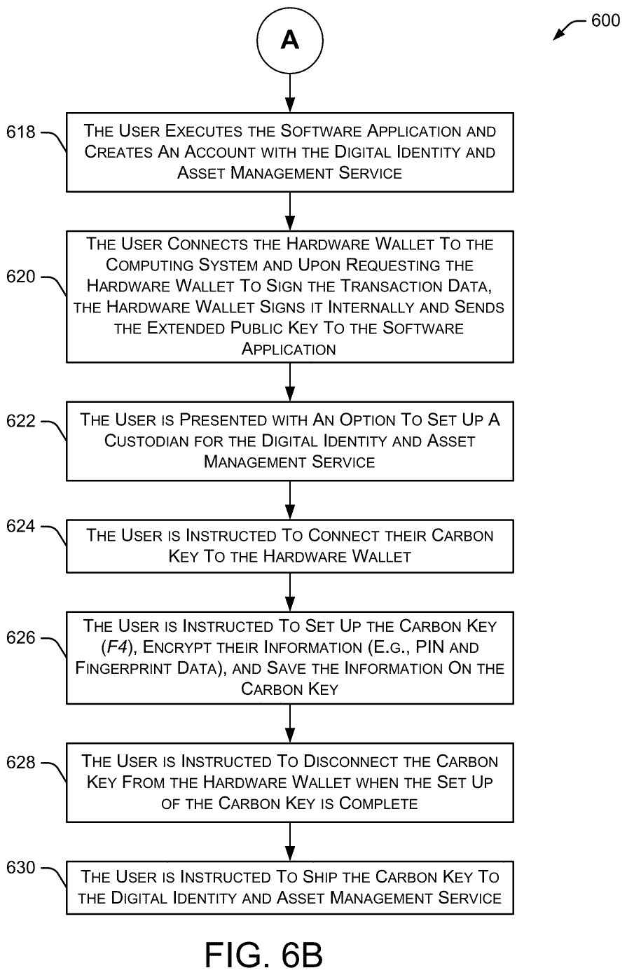

FIGS. 6A and 6B illustrate an embodiment of a method 600 for initializing a new hardware wallet and registering for a digital identity and asset management service. In the example of FIGS. 6A and 6B, the user purchases a hardware wallet and a carbon key, and chooses to register with the digital identity and asset management service. In this situation, certain processes are followed which may create other factors and keys that are encrypted, such as beneficiaries.

Initially, a user purchases 602 a hardware wallet and a carbon key from a vendor or other entity. The user receives 604 the hardware wallet and connects it to a computing system or another power source. The secure MCU in the hardware wallet generates 606 a random number, which becomes the Master Key0. After the Master Key0 is generated, the secure MCU generates 608 four additional authentication factors: F1, F2, F3, and F4. As discussed herein, these additional authentication factors are:

F1—hardware wallet factor

F2—user's PIN factor

F3—user's fingerprint factor

F4—carbon key factor

Method 600 continues as the user generates 610 a PIN (F2) using the hardware wallet display. The user's PIN is used to encrypt F2, so the result is encrypt(F2,PIN). The user then scans 612 their fingerprint (F3) using the fingerprint sensor in the hardware wallet. The user's fingerprint is used to encrypt F3, so the result is encrypt(F3,fingerprint). In some embodiments, the user is presented with an option to register with the digital identity and asset management service. In the example of FIG. 6, the user chooses to register 614 with the digital identity and asset management service.

The user downloads 616 a software application that is associated with the digital identity and asset management service) to a computing system, such as the user's laptop computer or desktop computer. The user executes 618 the software application and creates an account with the digital identity and asset management service. Creating an account may include providing a variety of information, such as:

User's email, name, address, and phone number

User's password for his/her account

User's three security questions (or any number of security questions)

The digital identity and asset management service verifies the user's email and/or phone by sending an email message and phone message. If the user's email and/or phone is verified, the digital identity and asset management service creates an account for the user. In some embodiments, the digital identity and asset management service may ask the user for additional information, such as social security number, drivers license number, passport number, and the like. The user then provides credit card information to pay for the digital identity and asset management service, reviews their account information, and confirms their desire to subscribe to the digital identity and asset management service. After confirmation by the user, the digital identity and asset management service generates public/private key pairs for the user and sends the public key to the software application executing on the user's computing system.

The user connects 620 the hardware wallet to the computing system and upon requesting the hardware wallet to sign the transaction data, the hardware wallet signs it internally and sends the extended public key to the software application. In some embodiments, the software application notifies the hardware wallet that the user has subscribed to the digital identity and asset management service. Upon receiving the public key from software application, the hardware wallet will store the public key and will use it to encrypt the carbon key data.

The user is presented 622 with an option to set up a beneficiary for the digital identity and asset management service. If user want to have a beneficiary for the digital identity and asset management service, the user may be required to provide various authentication information, such as social security number, drivers license number, passport number, and the like. The beneficiary will be asked to sign up an account in the digital identity and asset management service as well. But the beneficiary's account type will be beneficiary and is under (or associated with) the user's account. The signup process for the beneficiary may be the same as the user except the beneficiary does not need to set up credit card information.

After the beneficiary's account is set up, the software application will guide the beneficiary to enter their PIN2 and fingerprint2 in the hardware wallet. When the beneficiary enters this information, the hardware wallet will generate encrypt(F2,PIN2) and encrypt(F3,fingerprint2) accordingly.

After the beneficiary's account is set up, the user is instructed 624 to connect their carbon key to the hardware wallet. The user is also instructed 626 to set up the carbon key (F4), encrypt their information (e.g., PIN and fingerprint data), and save the information on the carbon key. In some embodiments, information associated with the beneficiary is also saved on the carbon key. For example, the encrypted factors that may be stored on the carbon key include the following:

encrypt(F2,PIN)

encrypt(F3,fingerprint)

encrypt(F2,PIN2)

encrypt(F3,fingerprint2)

F4

The data will be encrypted by user's public key (referred to as PubKey) and then stored on the carbon key.

The user is instructed 628 to disconnect the carbon key from the hardware wallet when the set up of the carbon key is complete. Finally, the user is instructed 630 to ship the carbon key to the digital identity and asset management service for safe storage (e.g., cold vault storage) of the carbon key. For example, a self-addressed return envelope may be provided for the user to ship their carbon key to the digital identity and asset management service.

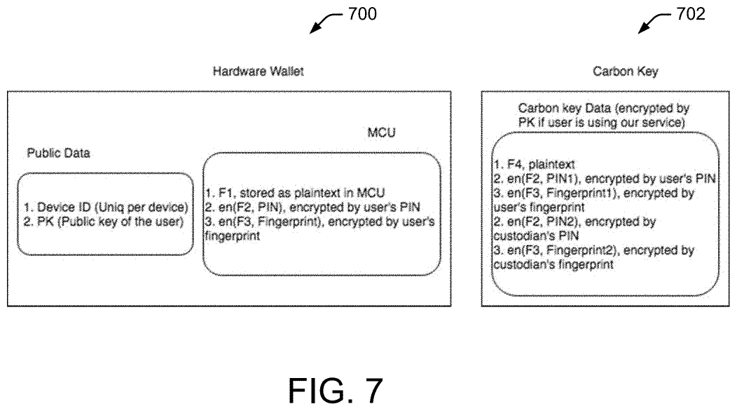

FIG. 7 illustrates an embodiment of the data stored in a hardware wallet 700 and a carbon key 702 after completing method 600 discussed above. As shown in FIG. 7, hardware wallet 700 contains a device ID, which is unique to hardware wallet 700, and the public key of the user. Hardware wallet 700 also contains various factors stored in the secure MCU. Additionally, carbon key 702 contains various factors, as discussed herein.

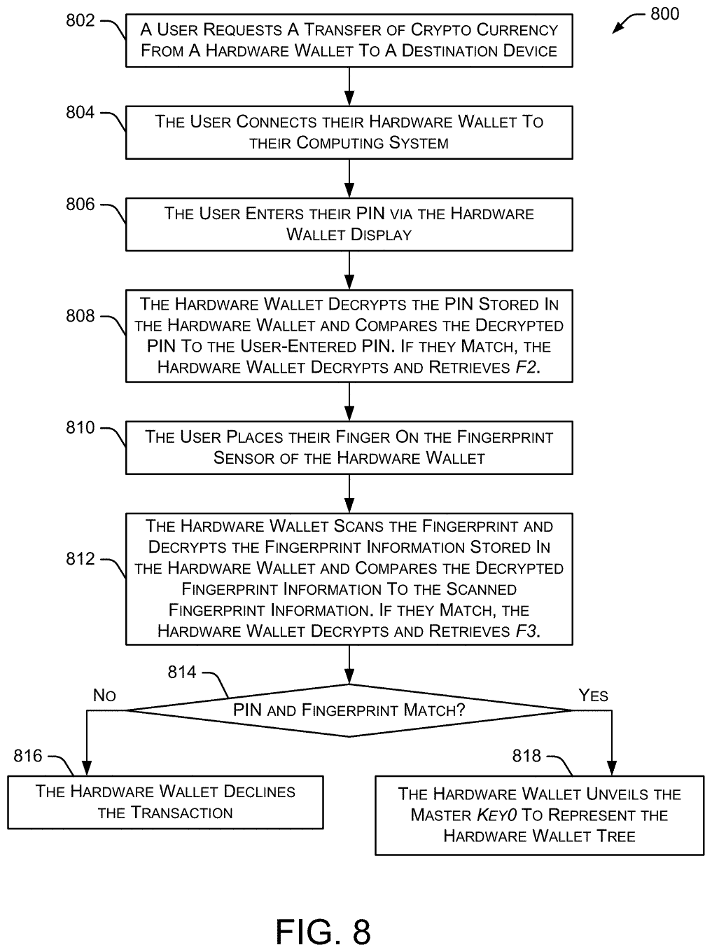

FIG. 8 illustrates an embodiment of a method 800 for signing transactions, such as transactions associated with crypto currency stored in a hardware wallet. Initially, a user requests 802 a transfer of crypto currency (or other asset) from a hardware wallet to a destination device. Method 800 continues as the user connects 804 the hardware wallet to a computing system or other power source before requesting the transfer of crypto currency. The user enters 806 their PIN (F2) using the display on the hardware wallet. The hardware wallet decrypts 808 the PIN stored in the hardware wallet and compares the decrypted PIN to the user-entered PIN. If they match, the hardware wallet decrypts and retrieves F2. For example, if the user's PIN is 123Abc, the hardware wallet will

decrypt(encrypt(F2,PIN),123Abc). If 123Abc is the same as the PIN, then the hardware wallet can decrypt and retrieve F2.

Next, the user places 810 their finger on the fingerprint sensor of the hardware wallet. The hardware wallet scans 812 the fingerprint and decrypts the fingerprint information stored in the hardware wallet and compares the decrypted fingerprint information to the scanned fingerprint information. If they match, the hardware wallet decrypts and retrieves F3. If both the PIN and the fingerprint information match 814 (i.e., both F2 and F3 are decrypted and retrieved), the hardware wallet unveils 818 the Master Key0 to represent the hardware wallet tree. The hardware wallet tree refers to the hierarchy structure of the multiple sub-keys derived from the master key. However, if either the PIN or the fingerprint information do not match, the hardware wallet declines 816 the transaction.

In the example of FIG. 8, since F1 is securely stored in the secure MCU of the hardware wallet, if F2 and F3 are decrypted and retrieved, the system has 3 of 4 factors required to validate and authenticate a signed transaction. With F1, F2, and F3 and using Shamir's algorithm, and using the MF/MSA rules discussed herein, the secure MCU in the hardware wallet can restore the Master Key0 and use it for key derivation in order to sign the transaction. In some embodiments, the comparisons and decryption operations discussed above are performed within the secure MCU in the hardware wallet.

In some situations, a user may need to restore and/or reset one of the factors which they initially set up with the hardware key. This could happen for one of many reasons, such as:

A user could lose their hardware wallet or fear that it was stolen

A user could forget their PIN

A user could unfortunately lose a limb and not have access to their thumb or finger which they used to create their biometric information

Even in any of these cases, a user can still decrypt and retrieve their Master Key0 and restore a new device or reset any of these factors. If a user is missing any one of the three required factors (F1, F2, or F3), they can still use F4, their encrypted carbon key with the other two factors to restore the Master Key0. As discussed herein, the carbon key can be stored by the user or stored by the digital identity and asset management service.

If the user loses two of their factors, there are two scenarios for restoration of the hardware wallet. For example, if the user loses both their PIN and loses a finger—or the user loses their hardware wallet and forget their PIN. In this situation, if the user has registered with the digital identity and asset management service and set up a beneficiary, they can restore their hardware wallet. The hardware wallet is restored by using a process to validate and send the user their carbon key and will enable the user to then use their beneficiary's PIN and biometric (e.g., F2K2 and/or F3K2 factors) to restore the hardware wallet.

In some situations, a user purchases a hardware wallet and a carbon key, but does not register with (or subscribe to) the digital identity and asset management service. In these situations, the user is responsible for securely and safely storing and retrieving their carbon key. As noted above, with their carbon key, the user can still restore their Master Key0 if they misplace or are missing one factor, such as one of: their PIN, their fingerprint, or their hardware wallet. However, if the user loses two factors, they cannot restore their Master Key0, even if they have the carbon key because they cannot achieve three factors that are necessary for authentication.

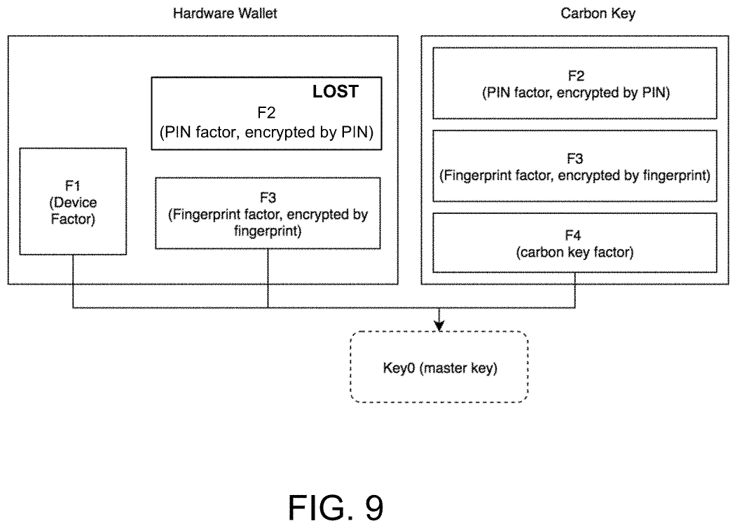

FIG. 9 illustrates an example situation in which a user has lost or forgotten the PIN (F2) associated with their hardware wallet. In the example of FIG. 9, the user can restore their Master Key0 by:

connecting their hardware wallet to their computing system or other power source

retrieving their carbon key and connecting the carbon key to the hardware wallet

choosing the “Restore from Carbon Key” option in the hardware wallet user interface and selecting the “Forgot PIN” option in the user interface

The hardware wallet will then communicate with the carbon key and discover that the user did not register with the digital identity and asset management service. The hardware wallet will then use the encrypted data stored in the carbon key (F4) directly. The user is then prompted to scan their fingerprint. If the fingerprint is verified, the hardware wallet has 3 of 4 factors (F1, F3, and F4), so the hardware wallet can retrieve the Master Key0. After the Master Key0 is restored, the hardware wallet will delete all of the initial data (e.g., keys) for each factor (F1, F2, F3, and F4). The user is then guided through an initialization process to reset all of the keys for each factor. The user will also be offered an opportunity to register for (or subscribe to) the digital identity and asset management service.

In another situation, if the user is no longer able to scan their fingerprint, they can restore their Master Key0 in a manner similar to the situation where the user forgets their PIN, discussed above. In this situation, the user selects “New Fingerprint” option (instead of “Forgot PIN” option with the previous example) to scan a different finger.

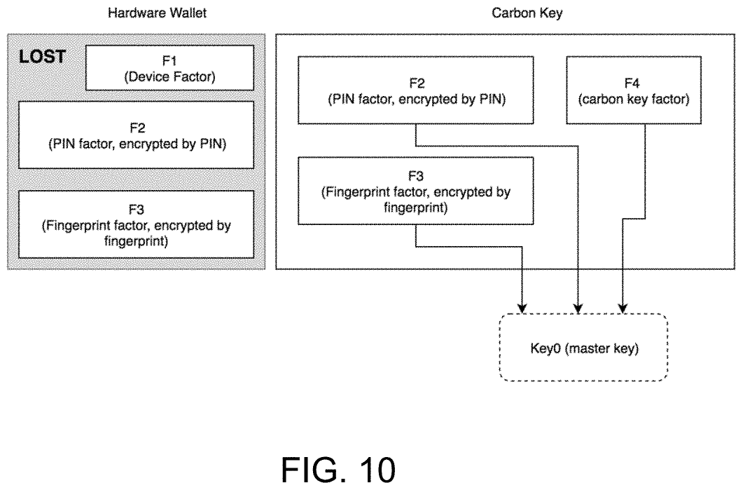

FIG. 10 illustrates an example situation in which a user lost their hardware wallet (F1) or the hardware wallet was stolen. In the example of FIG. 10, the user can restore their Master Key0 by purchasing a new hardware wallet. After receiving the new hardware wallet, the user connects the hardware wallet to their computing system or other power source.

The user chooses the “Restore from Carbon Key” option in the hardware wallet user interface, then selects the “Restore new Hardware Wallet” option. The user is asked to connect the carbon key to the new hardware wallet such that the hardware wallet can communicate with the carbon key to access the encrypted data stored in the carbon key (F4). The hardware wallet user interface will prompt the user to input their PIN and fingerprint into the new hardware wallet. At this point, the hardware wallet has 3 of 4 factors (F2 (user PIN), F3 (user fingerprint), and F4 (carbon key)) and can retrieve the Master Key0. After the Master Key0 is restored, the new hardware wallet will delete all of the initial keys for each factor (i.e., F1, F2, F3, and F4). The user is then guided through the process of setting new keys for each factor. Additionally, the user is given an opportunity to register for the digital identity and asset management service.

In the following example situations, the user has already registered for the digital identity and asset management service.

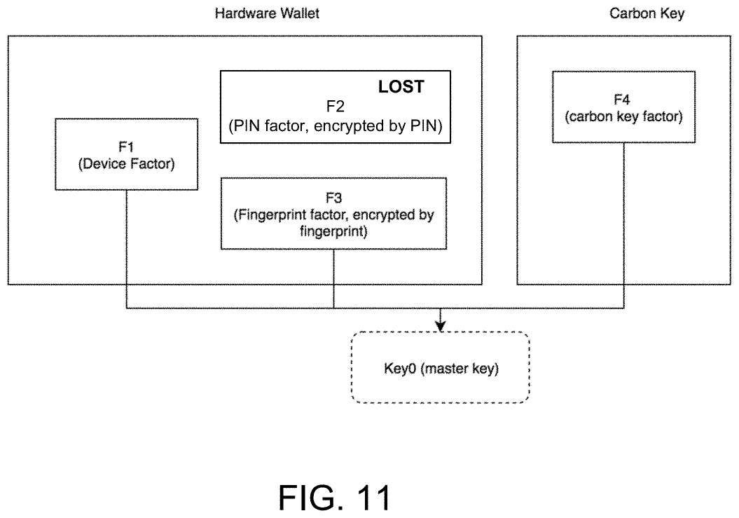

FIG. 11 illustrates an example situation in which a user has lost or forgotten the PIN (F2) associated with their hardware wallet. In the example of FIG. 11, the user is registered with the digital identity and asset management service, which is storing the user's carbon key. Since the digital identity and asset management service is storing the user's carbon key, the user initiates the restoration process online by, for example, signing into their account using the software application on their computing system. After signing into their account, the user selects “Hardware Wallet->Forgot PIN”. The user will be prompted for a second authentication factor (e.g., email or SMS). In some embodiments, a customer representative may call the user to confirm their identity.

The digital identity and asset management service performs a risk analysis based on the information received in authenticating the user. In some embodiments, the risk analysis includes analyzing the IP address of the user, when the account was created, when the hardware wallet was initialized, and the like. In some implementations, the software application executing on the user's computing system will show user information based on the risk analysis (e.g., show success if the risk is very low).

If the user's identity and account sign-in are confirmed, and before sending the user their carbon key (stored by the digital identity and asset management service), the service will create a strong, one-time passcode KeyOne and send it to the user's recovery email or other contact information. The digital identity and asset management service will then locate the user's hardware wallet ID (securely stored) and find the corresponding public and private key pairings (PubKey and PrivateKey pair). By using PrivateKey to decrypt the carbon key, the digital identity and asset management service can then retrieve the carbon key factor (F4). The service then encrypts the carbon key factor (F4) with a one-time strong passcode KeyOne and sends the carbon key to the user.

When the user receives the carbon key, they connect the carbon key to their hardware wallet and begin the restoration process. For example, the user may choose the “Restore from Carbon Key” option in the hardware wallet user interface, then select the “Forgot PIN” option. The hardware wallet checks the carbon key to discover that the user has registered with the digital identity and asset management service. The user is prompted to input the one time passcode KeyOne that was sent to their recovery email address. Upon validation of the one time passcode KeyOne, the hardware wallet can decrypt the carbon key and retrieve the carbon key factor (F4). The user is then prompted to input their fingerprint (F3). With these three factors (F1—hardware wallet, F3—user fingerprint, and F4—carbon key), the Master Key0 can be retrieved.

After the Master Key0 is restored, the hardware wallet can sign a transaction to delete all of the factors (F1, F2, F3, F4) and begin a reinitialization process in which the user is prompted to enter their new PIN and re-enter their fingerprint information. When the reinitialization process is complete, the user will be prompted to send back the newly re-encrypted carbon key with their new factor information to the digital identity and asset management service for storage.

In another situation, if the user is no longer able to scan their fingerprint, they can restore their Master Key0 in a manner similar to the situation where the user forgets their PIN, discussed above. In this situation, the user selects the “New Fingerprint” option instead of “Forgot PIN” option with the previous example.

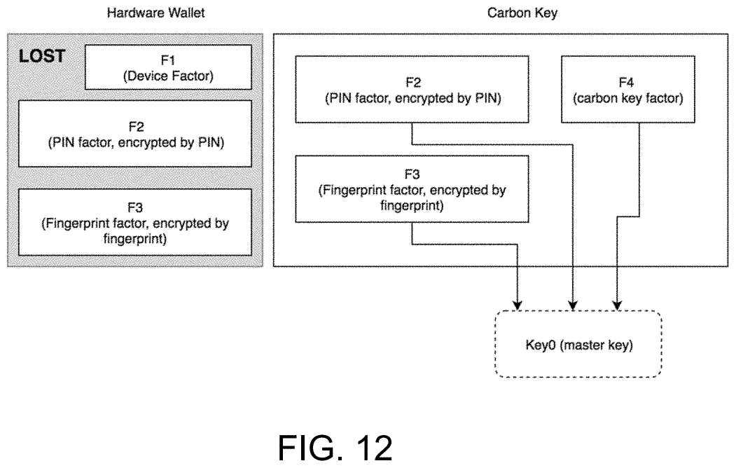

FIG. 12 illustrates an example situation in which a user lost their hardware wallet (F1) or the hardware wallet was stolen. In the example of FIG. 12, the user is registered with the digital identity and asset management service, which is storing the user's carbon key. Since the digital identity and asset management service is storing the user's carbon key, the user initiates the restoration process online by, for example, signing into their account using the software application on their computing system. After signing into their account, the user selects “Hardware Wallet->lost device”. The user will be prompted for a second authentication factor (e.g., email or SMS). In some embodiments, a customer representative may call the user to confirm their identity.

The user will choose a payment option to purchase a new hardware wallet and verifies their shipping address for the new hardware wallet. If the digital identity and asset management service needs additional information from the user, a customer representative may contact the user to confirm their identity and obtain any additional information needed.

In some embodiments, the digital identity and asset management service performs a risk analysis based on the information received in authenticating the user. In some implementations, the risk analysis includes analyzing the IP address of the user, when the account was created, when the hardware wallet was initialized, and the like. In some implementations, the software application executing on the user's computing system will show user information based on the risk analysis (e.g., show success if the risk is very low).

If the user's identity and account sign-in are confirmed, and before sending the user their carbon key (stored by the digital identity and asset management service), the service will create a strong, one-time passcode KeyOne and send it to the user's recovery email or other contact information. The digital identity and asset management service will then locate the user's hardware wallet ID (securely stored) and find the corresponding public and private key pairings (PubKey and PrivateKey pair). By using PrivateKey to decrypt the carbon key, the digital identity and asset management service can then retrieve the carbon key factor (F4). The service then encrypts the carbon key factor (F4) with a one-time strong passcode KeyOne and sends the carbon key to the user.

When the user receives the carbon key, they connect the carbon key to their hardware wallet and begin the restoration process. For example, the user may choose the “Restore from Carbon Key” option in the hardware wallet user interface, then select the “New Hardware Wallet” option. The new hardware wallet checks the carbon key to discover that the user has registered with the digital identity and asset management service. The user is prompted to input the one time passcode KeyOne that was sent to their recovery email address. Upon validation of the one time passcode KeyOne, the new hardware wallet can decrypt the carbon key and retrieve the carbon key factor (F4). The user is then prompted to input their fingerprint (F3) and their PIN (F2). With these three factors (F2—user PIN, F3—user fingerprint, and F4—carbon key), the Master Key0 can be retrieved.

After the Master Key0 is restored, the new hardware wallet can sign a transaction to delete all of the factors (F1, F2, F3, F4) and begin a reinitialization process in which the user is prompted to enter their new PIN and re-enter their fingerprint information. When the reinitialization process is complete, the user will be prompted to send back the newly re-encrypted carbon key with their new factor information to the digital identity and asset management service for storage.

The carbon key is an important part of the systems and methods described herein. When registering with, and using, the digital identity and asset management service, the user does not need to worry about the security of their carbon key because it is secured both in a physical storage facility and with the carbon key factor (F4). In some embodiments, the carbon key stored by the digital identity and asset management service may be insured. When needed, the user will be provided with their carbon key in a secure manner, as discussed herein. In particular embodiments, the described systems and methods encrypt and only provide selective information required on the carbon key (e.g., encrypted PIN or fingerprint) so only the minimum information required is send when shipping a carbon key to a user.

If a user chooses not to register with the digital identity and asset management service, the information on the carbon key will not be encrypted or include minimal information. In this situation, the user is responsible for storing and keeping the carbon key safe and secure for possible data retrieval in the future.

As discussed herein, users who register with the digital identity and asset management service can utilize several beneficiary services. When using these beneficiary services, if the user (owner of the hardware wallet) dies, there is a process managed by the service to 1) validate the user's death, 2) authenticate the beneficiary that the user designated, 3) send their carbon key to the designated beneficiary, and 4) enable the beneficiary to use their multi-factor authentication signatures to retrieve the Master Key0 and restore/reset the hardware wallet and all of the factors. Additionally, the beneficiary service along with the described MF/MSA system can also be leveraged by the registered user themselves in the case where they forget their passcode, lose their hardware wallet, and are unable to use their fingerprint.

In the case of a user's death and since the digital identity and asset management service is storing the user's carbon key, the user's designated beneficiary would begin the beneficiary transfer and restoration process online. The beneficiary would go to software application installed on the computing system and sign in with the beneficiary credentials they registered when signing up. For example, the beneficiary may sign in with their email, password, and/or other identifying information. The beneficiary selects the “Hardware Wallet->Beneficiaryship” option and is prompted to enter a second authentication factor, such as email or SMS. Additionally, the beneficiary is asked if they need a new hardware wallet and, if necessary, is presented with an option to pay for the new hardware wallet and enter a shipping address for the new hardware wallet.

Before sending the beneficiary the user's carbon key, the digital identity and asset management service also guides the beneficiary through a process to validate that the user has indeed died. This process may include, for example, a combination of online and offline information collection, review and verification of specific documents, such as a valid, apostilled original copy of a user's death certificate and other information to be defined by the service process. Once the user's death has been verified, the digital identity and asset management service will create a strong, one-time passcode KeyOne and send it to the beneficiary's recovery email or other contact information.

The digital identity and asset management service will then locate the user's hardware wallet ID (securely stored) and find the corresponding public and private key pairings (PubKey and PrivateKey pair). By using PrivateKey to decrypt the carbon key, the digital identity and asset management service can then retrieve the carbon key factor (F4). The service then encrypts the carbon key factor (F4) with the one-time strong passcode KeyOne and sends the carbon key to the beneficiary.

When the beneficiary receives the carbon key, they connect the carbon key to the hardware wallet to begin the transfer and restoration process. For example, the beneficiary may choose the “Restore from Carbon Key” option in the hardware wallet user interface and then selects the “Beneficiary Transfer” option. The hardware wallet then checks the carbon key to discover that the user has registered with the digital identity and asset management service. The beneficiary is prompted to input the one-time passcode KeyOne that was sent to their email or other contact information. If the one-time passcode KeyOne is validated, the hardware wallet can decrypt the carbon key and retrieve the carbon key factor F4, encrypt (F2,PIN) and encrypt(F3,fingerprint). Then beneficiary is then prompted to input their PIN (F2K2) and their fingerprint (F3K3). With these three factors (the beneficiary PIN (F2K2), the beneficiary fingerprint (F3K3), and the carbon key factor (F4), the hardware wallet and the beneficiary will have the three factors required to retrieve the Master Key0. After the Master Key0 is restored, the hardware wallet can sign a transaction to delete all of the factors (F1, F2, F3, F4) and begin a reinitialization process where the beneficiary will be prompted to enter a new PIN and fingerprint information. The beneficiary will be prompted to send back the re-encrypted carbon key with the new factor information to the digital identity and asset management service for safe storage. The beneficiary may also be prompted to register for the digital identity and asset management service, where they can designate and initialize their own beneficiaries.

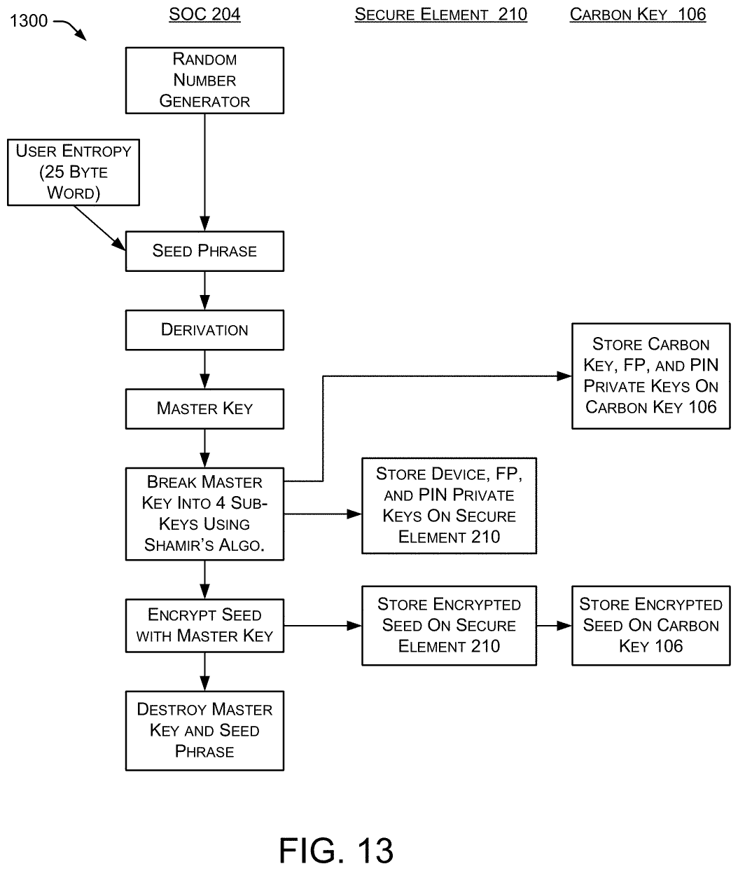

FIG. 13 illustrates an example workflow 1300 for generating a master key and an encrypted seed phrase. A random number generator creates a random number and a user generates a passphrase that is used as a salt to a derivation function. The user-generated passphrase increases the randomness of generating seed phrases, which are used to generate the master key. A seed phrase is generated using both the random number and the passphrase. A derivation function then generates a master private key. That master private key is broken into four sub-keys using Shamir's algorithm (discussed herein). In some embodiments, one or more of the sub-keys may be stored on secure element 210 and/or carbon key 106. For example, the device, fingerprint, and PIN private keys may be stored on secure element 210. And, the carbon key, fingerprint, and PIN private keys may be stored on carbon key 106.

In some implementations, the seed may be encrypted with the master key. The encrypted seed is then stored on secure element 210 and stored on carbon key 106. Then, the master key and the seed phrase are destroyed.

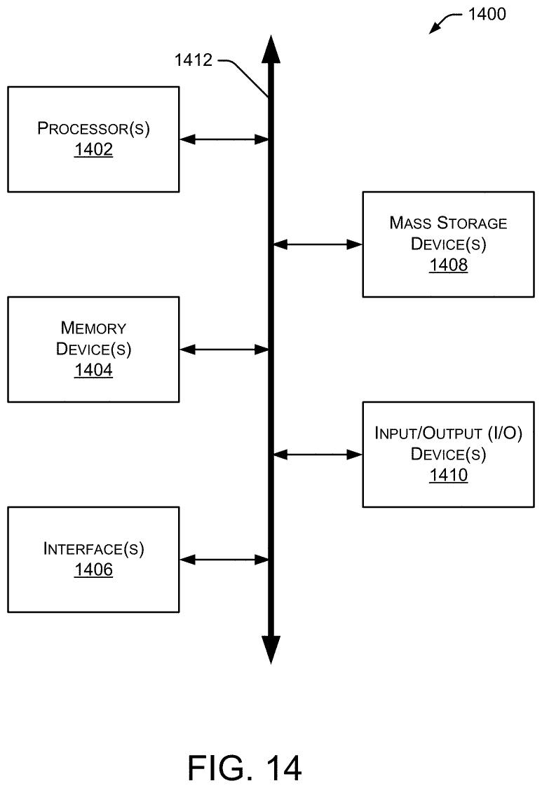

FIG. 14 is a block diagram illustrating an example computing device 1400. Computing device 1400 may be used to perform various procedures, such as those discussed herein. Computing device 1400 can function as a server, a client, a client node, or any other computing entity. Computing device 1400 can be any of a wide variety of computing devices, such as a workstation, a desktop computer, a notebook computer, a server computer, a handheld computer, a tablet, a smartphone, and the like. In some embodiments, computing device 1400 represents any of the computing devices or computing systems discussed herein.

Computing device 1400 includes one or more processor(s) 1402, one or more memory device(s) 1404, one or more interface(s) 1406, one or more mass storage device(s) 1408, and one or more Input/Output (I/O) device(s) 1410, all of which are coupled to a bus 1412. Processor(s) 1402 include one or more processors or controllers that execute instructions stored in memory device(s) 1404 and/or mass storage device(s) 1408. Processor(s) 1402 may also include various types of computer-readable media, such as cache memory.

Memory device(s) 1404 include various computer-readable media, such as volatile memory (e.g., random access memory (RAM)) and/or nonvolatile memory (e.g., read-only memory (ROM)). Memory device(s) 1404 may also include rewritable ROM, such as Flash memory.

Mass storage device(s) 1408 include various computer readable media, such as magnetic tapes, magnetic disks, optical disks, solid state memory (e.g., Flash memory), and so forth. Various drives may also be included in mass storage device(s) 1408 to enable reading from and/or writing to the various computer readable media. Mass storage device(s) 1408 include removable media and/or non-removable media.

I/O device(s) 1410 include various devices that allow data and/or other information to be input to or retrieved from computing device 1400. Example I/O device(s) 1410 include cursor control devices, keyboards, keypads, microphones, monitors or other display devices, speakers, printers, network interface cards, modems, lenses, CCDs or other image capture devices, and the like.

Interface(s) 1406 include various interfaces that allow computing device 1400 to interact with other systems, devices, or computing environments. Example interface(s) 1406 include any number of different network interfaces, such as interfaces to local area networks (LANs), wide area networks (WANs), wireless networks, and the Internet.

Bus 1412 allows processor(s) 1402, memory device(s) 1404, interface(s) 1406, mass storage device(s) 1408, and I/O device(s) 1410 to communicate with one another, as well as other devices or components coupled to bus 1412. Bus 1412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1400, and are executed by processor(s) 1402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” “selected embodiments,” “certain embodiments,” etc., indicate that the embodiment or embodiments described may include a particular feature, structure, or characteristic, but every embodiment may not necessarily include the particular feature, structure, or characteristic. Additionally, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that may be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions include, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a module may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. An apparatus comprising:
a carbon key configured to store at least one authentication factor associated with a user;
a hardware wallet configured to communicate with the carbon key, the hardware wallet including:
a fingerprint sensor configured to scan a fingerprint of the user;
a display configured to receive a personal identification number (PIN) from the user; and
a system on chip (SOC) configured to authenticate the carbon key, the fingerprint, and the PIN, wherein the SOC is further configured to sign a transaction based on authentication of at least two of the carbon key, the fingerprint, and the PIN.

2. The apparatus of claim 1, wherein the carbon key is configured to store the user's fingerprint and the user's PIN.

3. The apparatus of claim 1, wherein the hardware wallet is configured to store private keys for crypto currency associated with the user.

4. The apparatus of claim 3, wherein the transaction signed by the SOC is a transfer of crypto currency assets from the hardware wallet to a destination device.

5. The apparatus of claim 1, wherein the hardware wallet is further configured to associate a beneficiary with the hardware wallet.

6. The apparatus of claim 5, wherein the beneficiary has a fingerprint and a PIN associated with the hardware wallet.

7. The apparatus of claim 1, wherein the hardware wallet is further configured to communicate with a digital identity and asset management service via a software application on a computing device.

8. The apparatus of claim 1, wherein the SOC can sign the transaction without establishing communication with any external system.

9. The apparatus of claim 1, wherein the SOC includes a general purpose core and a secure core.

10. The apparatus of claim 1, wherein the SOC is further configured to apply user entropy to harden the security level of the derivation process associated with translating words to a master key.

11. The apparatus of claim 10, wherein the user entropy includes a passphrase provided by a user.

12. The apparatus of claim 11, wherein the SOC is further configured to generate a seed phrase based on the passphrase provided by the user and a random number generated by a random number generator.

13. The apparatus of claim 1, wherein the SOC is further configured to:
generate an encrypted seed phrase; and
store the encrypted seed phrase on a secure element and the carbon key.

14. A method comprising:
receiving a personal identification number (PIN) from a user of a hardware wallet;
decrypting a PIN stored in the hardware wallet and comparing the decrypted PIN with the PIN received from the user;
receiving a fingerprint from the user of the hardware wallet;
decrypting fingerprint information stored in the hardware wallet and comparing the decrypted fingerprint information with the fingerprint received from the user; and
if the PINs match and the fingerprints match, creating, by the hardware wallet, a master key to sign a transaction associated with the contents of the hardware wallet.

15. The method of claim 14, further comprising establishing a communication link between a hardware wallet and a software application executing on a computing system.

16. The method of claim 14, further comprising associating a beneficiary with the hardware wallet.

17. The method of claim 14, further comprising storing beneficiary information with a digital identity and asset management service.

18. The method of claim 14, further comprising storing beneficiary information in a carbon key associated with the hardware wallet.

19. The method of claim 18, further comprising storing the carbon key with the digital identity and asset management service.

20. The method of claim 14, further comprising authenticating a carbon key coupled to the hardware wallet.
